(19) United States
(12) Patent Application Publication
(10) Pub. No.: US 2008/0243034 A1
(43) Pub. Date: Oct. 2, 2008

(54) Body decompression technique for pain treatment

(76) Inventor: David Rubenstein, Westminster, CA (US)

Correspondence Address: FULWIDER PATTON LLP, 6060 CENTER DRIVE, 10TH FLOOR, LOS ANGELES, CA, 90045, US

(21) Appl. No.: 11/731,430

(22) Filed: Mar. 30, 2007

(51) Int. Cl. A61H 99/00

(52) U.S. Cl. 601/1

(57) ABSTRACT

A method for treatment of compressed fascial tissues on the human body comprising a two part process. The first part comprises a treatment of fascial tissues around the cranium and the second part comprises a treatment of fascial tissues along the torso and limbs. The first part administers a method of palpation to tactilely identify areas of compressed fascial tissue and treats identified areas using compressive and tractional forces applied to the area perpendicularly to one another until compression is released. The second part includes a sequences of stretching postures that elongate the tissues in the torso and limbs further relieving the body of compressed tissues. The second part is aided by use of an orientation device that provides reference points for commencement of a stretching posture and for directing movement thereafter. A platform device is also included for promoting a stretching posture and a balancing aid is provided for supporting the weight of the torso during select exercises.

### BACKGROUND OF THE INVENTION

1. Field of the Invention

The invention relates to the field of pain treatment, specifically fascia decompression.

2. Description of the Prior Art

Everyday, people and their bodies are subjected to a myriad of stresses that react on the person both mentally and physically. The mental and physical components of the body are considered by some, intertwined and when one portion is ailing, so too, does the other. Some medical practitioners understand that stresses create an impediment on the function and health of the human body as a whole.

One of the important areas sometimes neglected for treatment by individuals is the musculoskeletal system. The musculoskeletal system includes the connection of muscles with the skeleton, spine, brain and the connective tissues bridging these organs and structures together. Muscles and their connective tissue connect different portions of the skeleton from the top of the head down through the torso and all the way to the feet. The stresses of everyday activity that result from work, physical endeavors, tension producing worries, and exercise regimens produce a tensional imbalance on body tissues of the musculoskeletal system that can create contracture and compression on such tissues causing the systems of the body to decalibrate from their naturally balanced state. This naturally balanced state of tension is stored in brain memory as optimum tension levels that the various parts of the body should function under. Some will call this ideal balanced state a Perfect Motion Template where the amount of tension is coded within the brain remembering the optimum length between each body part and what the distance and tension should be between each and every joint. When different parts of the body veer from these optimal lengths, the tension, similarly becomes imbalanced and the tissue within the body can contract perpetuating reciprocating imbalances throughout the body. The result of such imbalances in the various systems of the body can often manifest themselves as physical pain or illness.

One method of treating the musculoskeletal system includes treating the spine and bones. Patients sometimes seek treatments by orthopedists and chiropractors to relieve compression or inflammation on adjacent tissues. Such treatments include readjusting the position of vertebrae to realign the spine and repositioning bone joints to fall back into their natural placement.

Other people experience pain indicating that muscles are tired, sore or damaged. Muscles can be a popular and common organ to treat to because of the relatively easy access to practitioners skilled in administering treatment. Some common techniques in treating muscles include receiving massages, performing resistance exercises, and stretching contractions in muscles. Efforts have been proposed using specific equipment to aid in stretching the muscles and the spinal column and can be seen in U.S. Pat. Nos. 5,472,401 and 7,087,005 to Roulliard et al. Some patients favor these treatments because of the sense of relaxation and immediate gratification from release of compressive forces on the body muscle tissue and spine. Also, the size of many muscles allows a person to easily identify and temporarily treat the source of pain. Others prescribe treatment to muscles under a rehabilitative theory of stretching limbs also using apparatuses such as those seen in U.S. Pat. No. 5,938,573 to Davies, III et al. and U.S. Publication Nos. 2007/0038161 by Bonutti et al. and 2006/0234841 to Koch. Others still propose strengthening the muscle by resistance exercises using free weights or the like as described in U.S. Pat. No. 6,666,801 to Michalow or by a specific type of exercise device for directing body movement through in U.S. Pat. No. 6,846,270 to Etnyre. While potentially beneficial to the treatment of muscular deficiencies, these methods and apparatuses suffer from the potential to aggravate injury using weights, machinery and unguided muscle elongation techniques where hyperextension or tissue inflammation can occur from unreferenced range of movement of the muscles and joints. Additionally, such treatments also place emphasis on the movement of muscles.

However, the relation of muscles to the biomechanics of the rest of the body can be complex requiring more diagnosis and prescribed treatment for deficiencies in muscular balance. One way to treat pain caused by damage and stress to the body is to calibrate or optimize the amount and control of contracted force produced by the muscles. Applicant described a system for treatment of the muscles, entitled Neuromuscular Calibration, as described in U.S. patent application Ser. No. 11/598,399, filed Nov. 13, 2006 that installs the optimized amount of force or contraction in the muscles contributing to the biomechanical balance. This system and other generally administered techniques can be therapeutic for the vast amounts of muscle tissue in the body. What some neglect, however, is the amount of connective tissue between the muscles in the bone that also suffers from the stresses and tensions of everyday activity.

Thus, when treating the human body and the musculoskeletal system, treatment of the muscles alone can be considered insufficient in alleviating the body of tension and contracture that can impair both muscle tissues and the skeleton. Bridging the connection between muscles and skeletal portions are connective tissues such as ligaments, tendons, and fascia. Left unattended, connective tissue progressively contracts on itself even when the connected muscle is stretched. Contracted connective tissue can thus also contribute to decalibration of the musculoskeletal system from its natural state of tensional balance. Thus, in order to alleviate stress and contracture forces on the musculoskeletal system, it can be beneficial to treat not only the muscles but the connective tissuc itself. Administering certain treatments to muscle tissue can also be applied to connective tissue and fascia by isolating an elongating these tissues.

One of the factors contributing to tensional imbalance in the connective tissues of the body are the differences in flexibility between tissue types. Different tissues support different degrees of tensile elongation. For example, fascia is less flexible than the muscle tissue it supports. Ligaments and tendons are less flexible than fascia. These connective tissues limit flexibility more than the muscle because of their unyielding nature. Hence, a greater potential for flexibility lies in the connective tissues, which are more resistant to elongation than in the muscle tissues.

The effect of flexibility/inflexibility within the human body is coordinated by the inherent abilities of the physical body components and their effect in producing forces necessary for human activity. The human body, especially the musculoskeletal system, is operative in part to deliver and receive forces. The musculoskeletal system provides rigidity from which force can originate. The musculoskeletal system is in a constant state of simultaneous relaxation and flexation and it creates a stable balance platform that allows the human body to maintain rigidity in certain simple postures such as standing up or lying down. Without this balanced rigidity, the body would curl up under the natural contracting nature of muscles. This balancing in opposing muscles can be understood as a line of dorsal rigidity that travels along the spine providing stability from the cranium to the feet. While beneficial in providing and maintaining posture, the line of dorsal rigidity also hinders the body during moments of sudden movement or change. Sudden changes in the line of dorsal rigidity can result in injury to tissues such as the back being thrown out causing pain to settle in.

Those skilled in the art recognize that this line of dorsal rigidity parallels the spinal system. Thus, the spine is one important factor in providing rigidity in the posture of the human body. Along the spine, there are high densities of connective tissue such as ligaments, tendons, and fascia. These relatively inflexible structures provide the means by which strength and rigidity is generated. When affected by stress and compressive forces, tensional balance between connective tissue and muscle loses equilibrium and the less flexible connective tissues tend to contract more without the balancing counterforce of the muscle tissue. This is particularly true of the specialized area of connective tissue, fascia, that surrounds muscles, bones, and joints that provide both support, protection, and structure to the body.

Fascia connects muscle tissue to bone throughout the body, in a complex series of connections from the skull down the spine to the outer limbs and the hands and feet. Hence, tension in the cranium can aggravate tension in the rest of the musculoskeletal system, and vice versa. As an imbalance occurs in one area of the body, the contracture of muscular and connective tissues imparts similar imbalances in the surrounding areas. What can occur then, is a chain reaction of tissue contractions that can spread from a single point to several points along the length of the body. Hence, compressed tissue in the base of the head can contribute to the creation of similar compressed tissue area down the length of the spine and spread to the rest of the body. Likewise, contractures in the body can become shooting pains felt throughout the system and in the head. When the musculoskeletal system is afflicted with contractions in its soft tissues, the pain can become overpoweringly distracting, if not near paralyzing to the performance of daily life.

From my review and study I believe that the ever-present compression to the head and brain is associated with a myriad of symptoms spanning physiological and physical symptoms such as headache, general agitation, elevated stress states and hyperactivity, difficulty concentrating and depression. It appears that the brain and head are compressed by the pressure exerted by the myodural bridge at the base of skull and brain. The myodural ridge is an anatomical structure that is a connective tissue “bridge”. It attaches the rectus capitis posterior minor muscle to the dura that surrounds the brain and spinal cord at the atlanto-occipital junction. Over time, especially with rising states of such physiological stress, more constriction from fascia and more compression from muscle contraction occurs around the head and upper torso. The fascia which is a completely integrated structure to the head, scalp, face, sinus, neck, shoulders and trapezius becomes fixed. The fixation locks into place an elevated compressive force which exists even while asleep because the fixation itself prevents the return of a normal tension in the fascia.

The key bio-mechanical features of perennial decompression are the disjointing of muscle and fascia to achieve a return to the original tension limits and the re-establishment of the degree of friction which naturally exists in the myofascial system. Unlike the long bone limbs of the body and parallel muscles, the head is spherically shaped which results in the total load from muscle contraction being multiplied inwardly by perpendicular laterally acting force vectors, which results in significantly increased cranial compression. It is the objective of my invention to identify the compression in the muscles and fascia in the area of the head, neck, torso by using palpation and understanding of the geometric patterns of the head. I locate the compressed tissue and apply a decompressive force for several seconds until a release is detected. The method may be applied to the upper/lower jaw, check bone, nasal area, forehead, surfaces surrounding the ear and occipital surfaces and the remainder of the scalp.

It can be seen therefore, that a need exists in the art for a method of treating imbalanced tension in the fascial tissues of the body, providing a full body decompression of the tissues.

### SUMMARY OF THE INVENTION

Briefly and in general terms, one embodiment of the present invention comprises a two-part fascial release system for treating tension imbalances within the fascial tissue of a patient. The first part is for treatment of cranial compression and a second part is for treating fascial compression along four segments of the human body with the second part aided by the use of an orientation marker providing orientation for movement of human body parts.

The method of the present invention seeks to equalize the compressive and restrictive forces of the musculoskeletal system in what Applicant terms a Fascial Release System (FRS). The FRS specifically targets the fascia of the head, torso and limbs so as to maximize neuromuscular efficiency, thereby attenuating an imbalance of tension on the system in an effort to return to musculoskeletal system back to a harmonious balanced state. The FRS focuses on releasing restrictions on flexibility in the fascial tissues using techniques designed to promote natural elongation of fascia in an effort to cause a shift and transformation in the fundamental flexibility of the tissues. The FRS focuses a systematic approach to releasing compression generated within the fascial tissues following a dorsal line of rigidity that travels vertically through the body that some medical practitioners will understand as the dorsal line of accumulated force. This dorsal line of accumulated force is situated at the convergence of various physical structures and the biomcchanical forces moving through the body. The dorsal line of accumulated force is defined as paired lines of force traversing from the crown of the cranium down through the back of the neck and flanking the sides of the spine through the torso and continuing through the gluteal region down through respective legs into the base of respective feet. There is a brief divergence and rejoining behind the kneed. The preferred embodiment of the present invention uses a systematic approach to treat fascial tissues along this dorsal line of accumulated force, thereby promoting a full-bodied decompression of imbalance tensions.

The FRS treats pain resulting from imbalanced tensions in the connective tissues along the entire body by splitting treatment between the cranial area and the rest of the body. The facet of my FRS for treating the cranial portion of the body is under a sub-system I call Cranial Decompression that specifically targets head-related fascia using a specialized form of palpation. The cranial decompression facet of my method includes applying a manual palpation to a patient's head and identifying areas of compressed fascial tissue. Upon identifying areas of compressed fascial tissue, a compressive force is applied with a finger or hand on the identified area inward toward the core of the cranium. A second tractional force is applied in a direction perpendicularly away from the compressive force along the cranial skin surface with both forces maintained until a release of fascial tension is sensed by the practitioner. Without releasing the compressive or tractional pressures, further compression and traction movements are administered to an identified area until subsequent releases of fascial tension are sensed. Further palpation is administered to the patient's head identifying areas of compressed fascial tissue and re-applying the procedure to various locations of the head that require decompression of tension from the fascial tissue.

In one embodiment, my method may include a second part sequence of muscular postures to release tension in the fascial tissues along the torso and limbs. This facet for treating compression of the body is under a subsystem I call The Series 8. It consists of four segments, segments 1-4 performed for each side of the back. To facilitate this sequence of postures, cruciform orientation markers may be placed on the floor surface. A first segment, Segment 1, includes positioning the patient in a sitting position on the orientation marker with one leg extended straight out and the foot and ankle of the other leg tucked inward towards the body with the torso straight up. The legs and hips of the patient are then adjusted in relation to the orientation marker and the patient instructed to round his or her head and spine forward while reaching for the foot of the extended leg. The sequence for Segment 1 continues into a posture that releases the stretch wherein the patient proceeds into the next segment, Segment 2, stretching the same side of the body. In segment 2, the patient will orient himself in position similar to Segment 1, to similarly extend the same leg out forward while adjusting his legs and hips in relation to orientation marker. However in this stretch sequence, the torso is shifted forward and down while maintaining a straight back and spine. Similar to Segment 1, the patient proceeds into a stretch that releases the stretch in Segment 2 and proceeds to Segments 1 and 2 on the other side of the body.

Segment 3 includes a stretching sequence performed twice targeting the upper leg with variations including a straight knee and a bent knee. The sequence generally includes orienting the patient standing on the orientation marker with his or her feet positioned perpendicular to one another on perpendicular lines of the orientation marker with his or her heels in contact with one another. Lines are demarcated outwardly along the perpendicular lines and the patient is instructed to step each foot outwardly along the perpendicular line to engage the respective demarcations. The patient is instructed to bend his or her knees slightly with hips and shoulders squared perpendicular to the line of the foot of whichever side will be stretched. The torso is then bent forward into a mild hamstring stretch. Releasing this position, the patient is instructed to raise the torso upward and to slowly lower back down toward the foot leaning to the outside of the leg being stretched. The patient may slide his or her hands down along the side of the leg towards the floor to support the torso weight with the fingers on the floor in a tripod position. The upper body weight is then slowly shifted forward over the feet shifting the belly button into vertical alignment over the ankle joint. The opposite leg is then extended to place that foot behind the first foot and held in position for a stretch. The opposite foot is then lifted slowly off the ground, to cross that leg over the first leg, and the two legs are squeezed together while the head is lowered to stretch the back of the neck. Segment 3 is then repeated for the same leg however instead of bending both legs, the leg targeted for stretching is maintained straight while the torso is bent forward into the hamstring stretch.

My method may also include Segment 4 to target the calf, Achilles' tendon, and foot area. Here I incorporate a platform placed at an inclined angle relative to the horizontal floor surface. The posture commences with placing the target forefoot on the board with such forefoot turned slightly inward. The heel of the foot is held in firm contact with the floor itself. The tissues are stretched by standing up straight and moving the hips slightly forward.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is diagrammatic view of the Fascial Release System of the present invention;

FIG. 2 is a diagrammatic view of a patient's head to be treated by the Fascial Release System show in FIG. 1;

FIG. 3 is a diagrammatic view showing compressive forces applied to the head shown in FIG. 2;

FIG. 4 is a diagrammatic view depicting release of the procerus of the head shown in FIG. 2;

FIG. 5 is a partial front view depicting locations for application of eye release forces of the head shown in FIG. 4;

FIG. 6 is a side view of the head shown in FIG. 2 depicting application of release forces for temporal release;

FIG. 6A is a side view of the head shown in FIG. 2 laid in supine orientation;

FIG. 7 is a rear view of sections 1, 2, 3, and 4 of patient's body to be treated by The Series 8;

FIG. 8 is a schematic representing a cruciform orientation device for use in The Series 8;

FIG. 9 is a partial rear view of Segment 1 of the human body shown in FIG. 7;

FIG. 10 is a partial rear view of Segment 2 of the human body shown in FIG. 7;

FIG. 11 is a partial rear view of Segment 3 of the human body shown in FIG. 7;

FIG. 12 is a schematic view depicting foot placement on the orientation device shown in FIG. 8 during a stretching posture of Segment 3;

FIG. 13 is a partial rear view of Segment 4 of the body shown in FIG. 7;

FIG. 14 is a schematic representing the use of a platform during a stretching posture of Segment 4.

FIG. 15 is a flow diagram describing a method of using the present invention shown in FIG. 1;

FIG. 16 is an illustration of a patient in a starting posture of the Series 8; and

FIG. 17 is a schematic illustrating the sequence of a Step Down Technique used in the Cranial Decompression.

### DETAILED DESCRIPTION OF THE PREFERRED EMBODIMENTS

The human body suffers from a myriad of maladies. Among certain maladies is a deficiency in maintaining properly balanced tension between contractive and expansive forces within the musculoskeletal system. There are those among the population that spend, for example, several hours a day either in a sedentary sitting position, straining their eyes and head in thought while staring at a computer screen or in physically demanding labor that will sometimes require repetitive motions within a demanding work environment. Performing exercise on a regular basis is helpful in maintaining musculoskeletal strength, however, many general exercises do not target the connective tissue between muscles and bones, i.e. the fascia, and instead of elongating and balancing the fascial tension further compression is added creating the potential for damage in soft tissues such as muscles. Compressed fascia can lead to biomechanical inefficiency resulting in musculoskeletal conditions that can benefit from the elongation of muscles and their connective tissues. My process described herein is a method of treating compressed fascial tissues that provides a release of fascial tension to help return compressed areas of the musculoskeletal system back to a balanced state. My system mechanically isolates fascia and connective tissue and then decompresses these tissues to achieve the bio-mechanical efficiency.

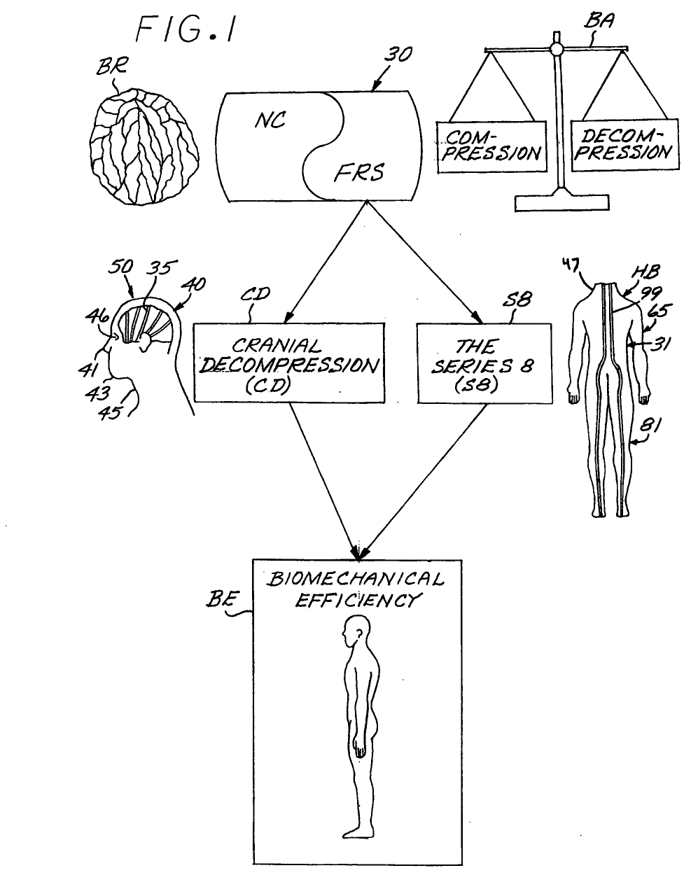

Referring to FIG. 1, one embodiment of Fascial Release System includes a two-part system 30 labeled the FRS. The first part of the FRS is labeled Cranial Decompression (CD) and targets the fascial tissues covering the human head 50 and cranium 40 using a guided technique to target and release compressed fascial tissues 35. The second part is a sequence of fascial stretches targeting the human body HB primarily from the neck down 47 and labeled the Series 8 (S8). One goal of this embodiment of the FRS 30 is to use the two parts, Cranial Decompression CD and Series 8 (S8) to administer a full body treatment contributing to biomechanical efficiency BE by promoting a balance BA of compression and decompression in tissues.

Cranial Decompression

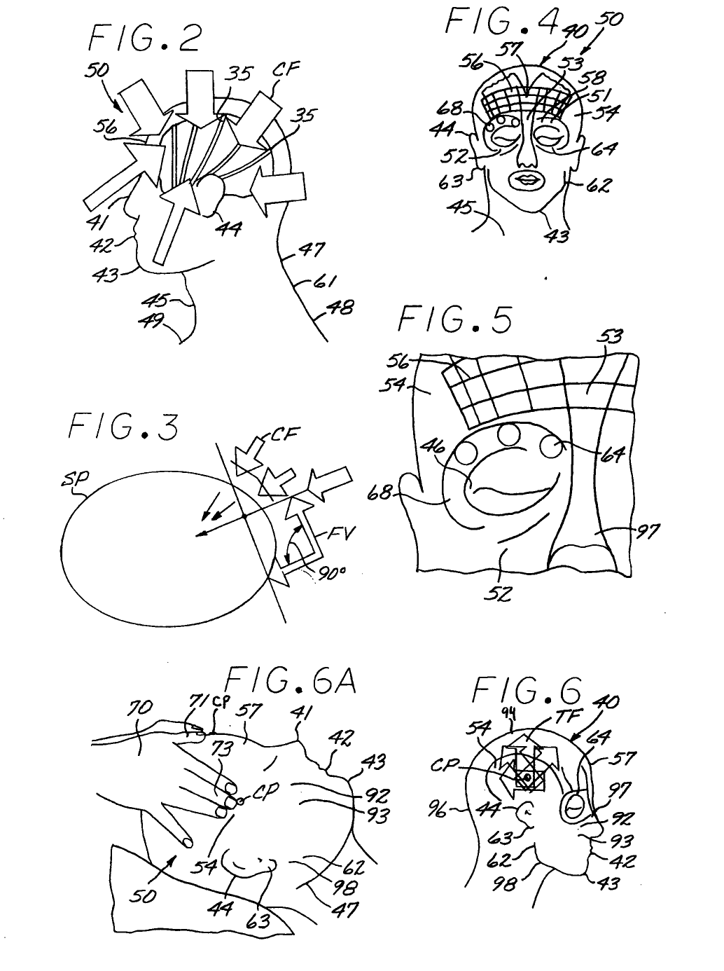

The Cranial Decompression technique CD involves treatment of the fascial tissue on the head, brain, neck and upper torso by countering the compressive physical forces which occur along the dorsal line of tension. Referring to FIG. 2, the Cranial Decompression portion CD of the FRS system 30 targets a patient's head 50 by administering a manual palpation to the fascial tissues 35 which connect to the muscle tissue surrounding cranium 40. Fascial tissues 35, as well as the other lines radiating from the point just forward of the ear 44, correspond to the cranial portion of the dorsal line of accumulated force. The cranium 40 is applied with a different treatment than the rest of the body, because the spherical structure of the head is different than that of the long limbs and torso of the body. In addition, the brain is situated within the cranium with its own specialized system of connective tissues. Unlike the rest of the body which contains long bones paralleled by muscle, the head is curved or spherical with the connected muscles and fascia of the head also generally arranged spherically. The brain is surrounded principally by a tough structural layer called the dura mater which is directly connected to muscles and fascia of the head. When tension is extended to the dura mater, compressive forces CF are also exerted on to the brain, the results of which can be seen in symptoms such as neck pain, shoulder pain, muscular knots in the shoulders, mental agitation, lack of mental focus and clarity, nervousness, port concentration, etc.

My Cranial Decompression method involves the practitioner applying compressive forces following the spherically arranged fascial tissues 35 along the patient's head 50 exerting pressure on these tissues from a multitude of directions on the cranium 40. It will be understood that there are some parts of the torso 31 connected to the musculoskeletal portion of the cranium 40 that will also benefit from application of the Cranial Decompression technique CD in order to treat compression of fascial tissues on the head 50. Among these body parts are the neck 47, trapezius 48, shoulders 49, throat 43, and spine 61. Other portions of the head that will be referenced during application of the entire FRS 30 treatment include a nose 41, lips 42, chin 43, ears 44, throat 45, and eyes 46.

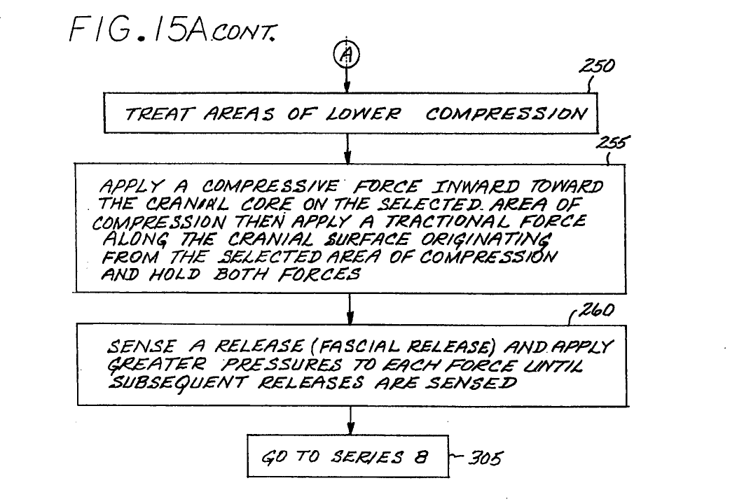

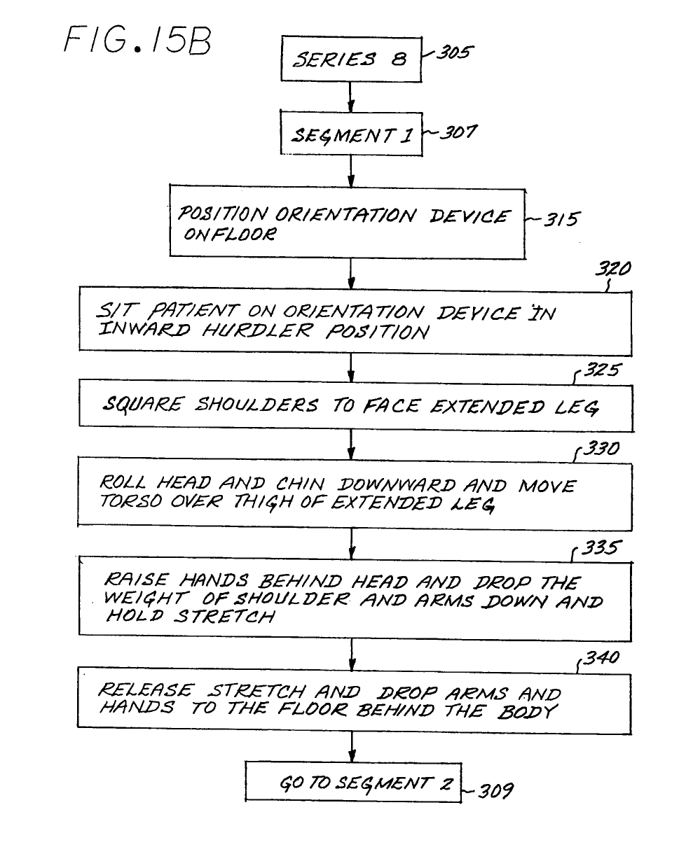

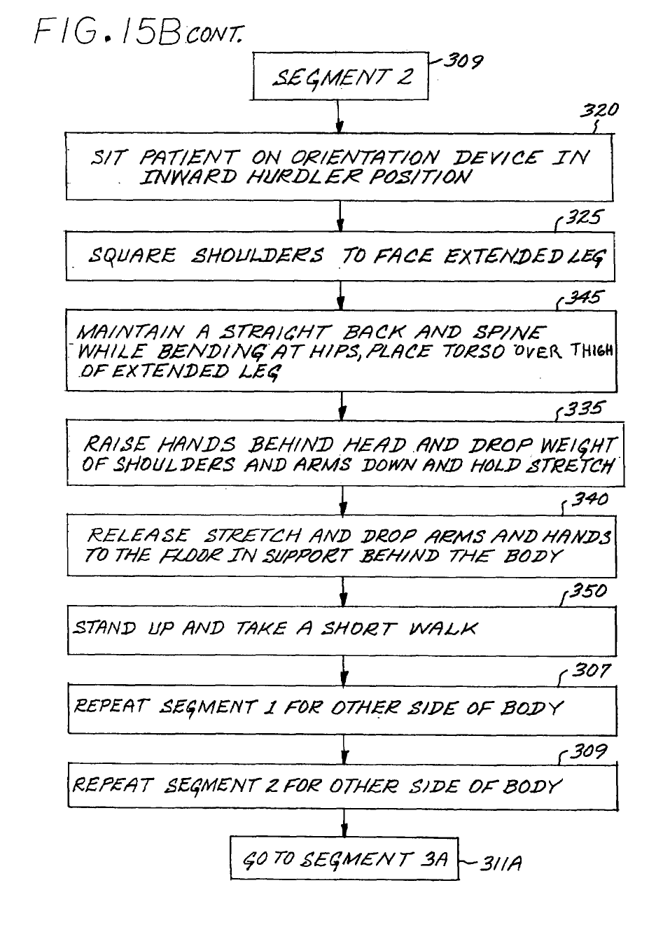

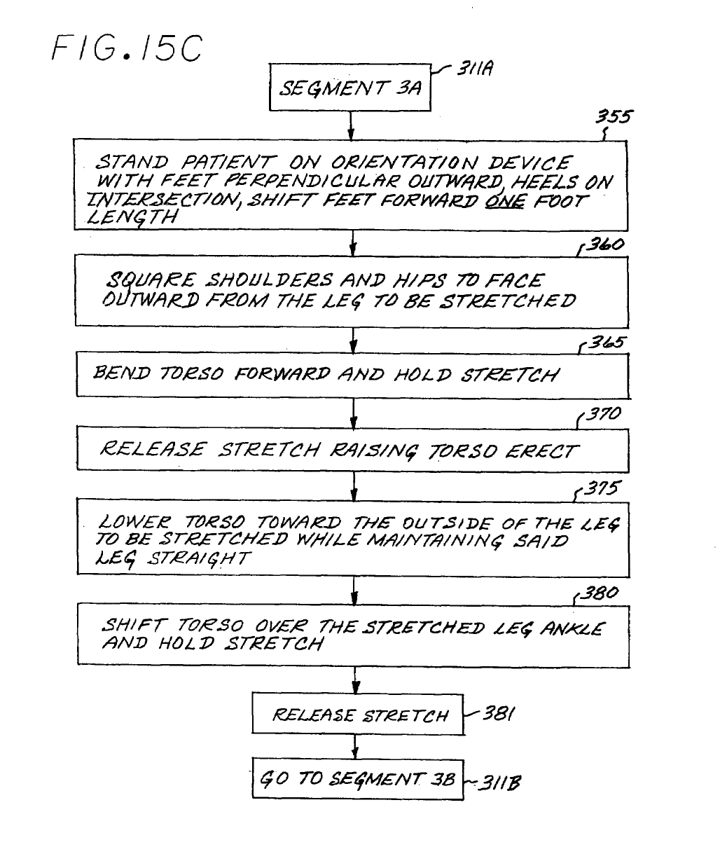

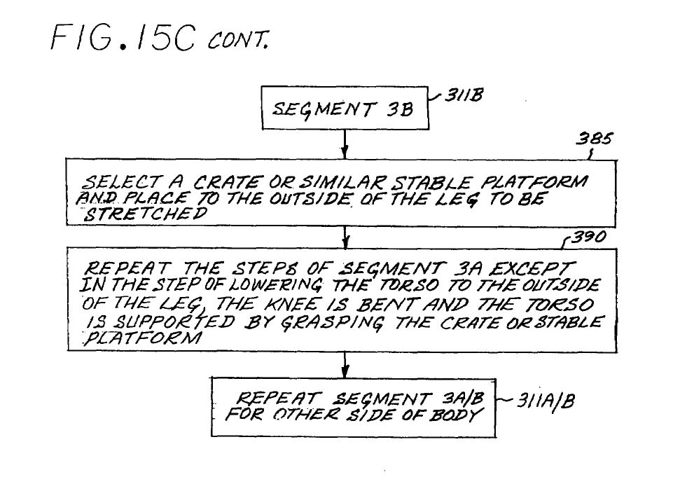

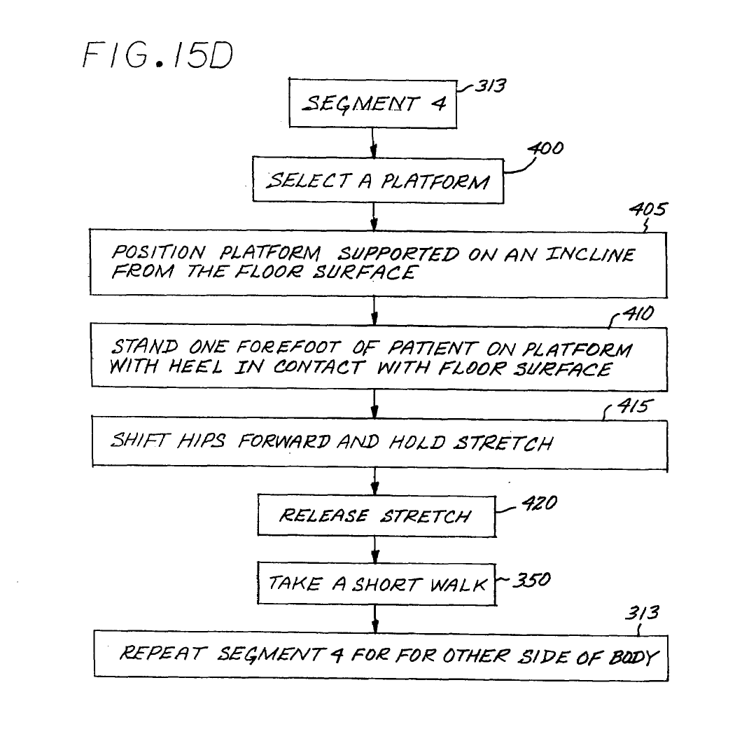

Referring to FIG. 3 the compressive forces CF reacting upon a head is depicted on the spheroid SP representing the general shape of a human head. The total load of muscle contraction is multiplied by an inwardly perpendicular lateral force vector FV accounting for total compressive forces on the cranium. In general, the administration of the cranial decompression technique CD involves the palpation of the entire cranium to identify areas of fascial contraction/restriction The technique is described in FIGS. 15A and 17. In steps 210-215, I position the patient supine on a table and wipe the face and ear areas with a cloth or pad moistened in witch hazel. I then seek to disjoint muscle and fascia to the extent tissues are returned to near an original state of tension by first assessing the relative freedom of movement in tissues in step 220. The technique involves using fingers to apply gentle and slow decompression movements using only enough pressure to meet and engage the fascia and muscle tissue. The pressure will be applied by the fingers along the surface of the skin and may be broken down into two applications of force (FIG. 17). The first application of force is a compressional pressure movement CP and the second application, a tractional force movement TF. The sequence and pairing of a compressive pressure movement CP followed by a tractional force movement TF is called the Step Down Technique. The direction of the compressive pressue CP is generated by pressing generally from the superficial surface of the skin inwards towards the core of the head. This compression segment of the technique (step 240) engages and holds the compressed fascia and muscle tissue. While holding and maintaining the compression, the practitioner applies a tractional force TF along the second line of force perpendicular to the inward compressing pressure CP and along the cranial surface. The tractional force TF is held in position until the practitioner feels a release of compression in the fascia and muscle tissue (step 245), and without lessening the compression or traction, the practitioner performs another Step Down and applies another set of compression and traction movements CP and TF and waits for a second release. The amount of movement felt in a release is similar in magnitude to the amount of movement experienced between two successive decompression movements. The practitioner typically experiences three to four releases and sometimes up to five or six from the same areas of treatment. In steps 250-260, the practitioner will then again reassess for freedom of movement in skin, fascia and in muscle tissue and the Cranial Decompression technique CD is repeated as necessary over various parts of the head 50.

I have identified several common areas of cranial fascia where application of the Cranial Decompression techniques CD should be administered. However, those skilled in the art will recognize that other specific areas of the cranium may benefit from use of the described technique and the areas described herein are for exemplary purposes only. For example, referring to FIGS. 4-6, the human head is represented in different views with particular cranial and muscle areas referenced. Among the primary muscle groups referenced and selected from in step 230, are the frontalis 57, procerus 53, corrugator supercilii 58, temporalis 54, masseter 62, auricle 63, orbicularis oculi 64, infraorbital foramen 92, levator labii 93, occipito frontalis 94, and suboccipital frontalis 96. Individual techniques administered to these primary muscle groups referenced will be described.

Forehead Release

The forehead 56 release targets the frontalis 57 muscle group (FIGS. 4, 6-6A). The practitioner will, by palpation, locate an area of compressed fascial and muscle tissue around the frontalis 57 area and apply the first compressive pressure movement CP by using thumbs 71 on the bottom rim of the forehead 56. While holding the first compressive pressure movement CP inward towards the core of the head, the second tractional force TF is applied above the location of the compressed pressure movement in a direction toward the crown of the cranium 40. I recommend performing the Step Down Technique (FIG. 17) at this point in each muscle group. In doing so, just enough traction should be used to encourage fascia and muscle tissue of the area to elongate without sliding the fingers over the skin. When a release of compressed fascial tissue is sensed, further compression and tractional force should be applied until a second release is felt. Once the procedure is completed, the practitioner will gently and smoothly release the decompression forces and a reassessment of the fascial tissue will be performed.

Procerus Release

For the procerus (seen in FIG. 4) the practitioner may position hands 70 similar to the position shown in FIG. 6A except that the thumbs 71 are positioned over the procerus 53. The palms 69 are simultaneously applied to both sides of the temporalis 54 placing the respective thumbs 71 proximate the center of the procerus 53 and a compressive pressure CP is applied inward with the thumbs.

Corrugator Supercilii Release

Referring to FIG. 5, in one embodiment, the practitioner may target an area compressing just above corner of the eye 46 and toward center of head. The tractional force is applied toward either the right or left temporalis 54 in a slight oblique and superior direction from lateral.

Temporalis Release

Referring to FIG. 6, around the temporalis 54, pressure is applied generally along the sides of the cranium 40. Beginning with the compressing force placed inward from the side of the cranium 40, the tractional force is applied in successive movements away from the compression force following a series of linear tractional lines of forces performed around the compressive force.

Masseter Release

In some embodiments, my method involves applying cranial decompression to the right and left side masseter 62 by placing the palm 69 of one hand 70 (FIG. 6) under the inferior edge of the mandible 98 and applying the compressive force near the mandible joint inward towards the core of the cranium 40. The tractional forces are applied in directions diagonally from the corners of the lips 42 toward the temporalis 54 along directions of muscle.

Ear Release

To release fascial tension around the ears 44 (FIG. 6) both left and right ears 44 are decompressed simultaneously. The practitioner may grasp the ears and apply a compressive force to the lower portion of the auricle 63 by pinching this portion between a thumb and finger. A tractional force is then applied drawing the lower auricle portion downward toward the torso. Next an upper portion of respective auricle 63 are grasped similarly to the lower portion while the accompanying tractional force draws the auricle upwardly along side the cranium 40. Lastly, the rear portion of auricles 63 are compressed and the tractional force draws the ears 44 rearward towards the suboccipital frontalis 96.

Eye Release

]. Fascial tissue around the eyes 46 (FIG. 5) are treated simultaneously and decompressed by the practitioner placing a compressive pressure movement CP around the orbital part of the orbicularis oculi 64. The compression is placed above the eye 46 just below the forehead 56 and held in place until a release is felt. It has been found beneficial to perform decompressive movements using three fingers around the superior portion of the orbital part of the orbicularis oculi 64.

Sinus Release

The sinuses 52 are located below respective eyeball sockets 68 flanking both sides of the nasal cavity 97 (FIGS. 4 and 5). Decompression on the fascial tissue around the sinuses 52 is achieved by the practitioner applying a compressive pressure simultaneously on left and right sides of the nasal cavity 97. The compressive pressure is held on respective sinuses 52 while tractional forces are maintained on depressions bilateral to the nose.

Oblique Nasal Area Release

The nasal area release requires two different positions performed simultaneously for decompression of fascial tissue. The right and left side areas are performed separately from one another. The superior position is located just below 53 where a compressive pressure is maintained (FIGS. 4 and 5). The tractional forces are directed diagonally upward toward the corners of the cranium 40. The inferior position is located below the sinus 52. The interior position is treated by maintaining a compressive pressure on this area inwardly towards the core of the cranium 40.

Comers of the Skull

I decompress the fascial tissue around the corners of the cranium 40 by separating opposing thumb and forefinger of the same hand from one another with one of the fingers positioned near the upper corner of the cranium 40 and the opposing finger positioned above the orbicularis oculi 64 (FIG. 6). Simultaneous tractional forces are applied by respective fingers in the direction of the opposing finger.

Occipitofrontalis

I decompress the occipital frontalis 94 (FIG. 6) by placing the palm 69 of one hand 70 the suboccipital frontalis 96 and the other hand on the forehead 56. I apply a compressive pressure with the palm 69 of each hand while the fingers apply a tractional force.

Suboccipital Release

In one embodiment of my invention I treat the suboccipital muscles 96 (FIG. 6) near the base of the cranium 40 by placing the palm 69 of one hand 70 underneath the cranium base and applying the tractional force upward and rearward from the cranium or laterally toward wacfh side of the head.

Scalp

It is often helpful to grasp the patients hair and apply strong pulls to draw the scalp away from the fascia to compound the effect of the decompression.

Series 8

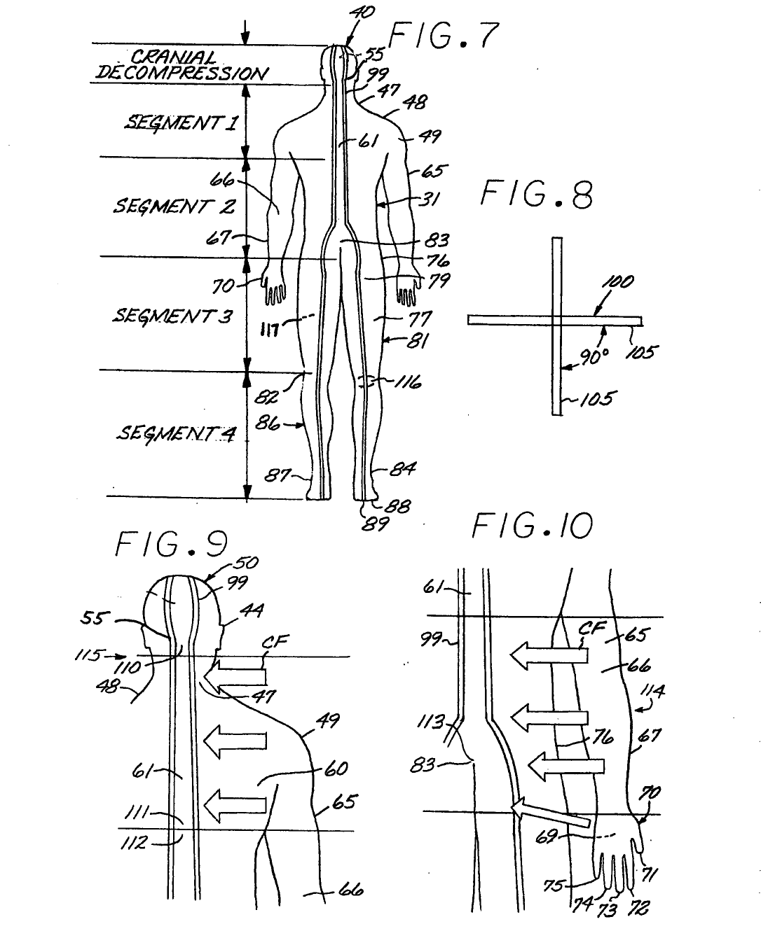

In one embodiment of my invention, I employ the Series 8 as a second part of my Fascial Release System 30 which can be generally described as a sequence of postures targeting segments of the body for elongation of muscles and their connective fascia. After performing the Cranial Decompression portion of the FRS, the non-cranial muscles should also be decompressed of fascial tension so that a full body decompression is sought balancing the musculoskeletal system from head to toe. Referring to FIG. 7, the postures target the dorsal lines of force 99 that run parallel to one another from the cranium 40, flanking both sides of the spine 61, and down along each leg 81 to the base of the feet 88. Each series of postures targets these dorsal lines 99 within four distinct segments of the body below the cranial portion. I work on each segment independently, one side at a time. The boundaries between the four segments can be defined by specific anatomical features. Segment 1 (80) is defined as the area between the occiput condyles 110 to the T-9 (111) or T-10 vertebrae 112. From these vertebrae to the sacroiliac joint 113 is Segment 2 (85). The dorsal lines 99 digress from each other in this segment as they continue below the lumbar area 114 to the back of the legs 81 through the posterior hips 76 and gluteal area 79. Segment 3 (90) is defined as including the ischial tuberosity 116 down to the back of the knee 82 passing behind the center of each knee. When a dorsal line of force 99 passes behind the center of a knee 82, it splits briefly in two to sub-lines each digressing away from the center line. The sub-lines re-converge in Segment 4 and continue down the main line through the center of the calf 86 into the Achilles' tendon 84. The dorsal line 99 moves toward the bottom of the foot exiting between the first and second toes 91.

The Series 8 specifically targets in Segment 1, the cervical/thoracic portions 115 of the body (FIG. 9). The sequence progresses downward in Segment 2 focusing on the lumbar 114 and sacral areas 83 (FIG. 10). Segment 3 (FIG. 11) can be divided into targeting the upper and lower hamstrings 77 and in Segment 4 (FIG. 13), stretches that tissue in the calf 86, Achilles' tendon 84, and foot 88.

The order and performance of stretches for each segment can be performed from either side and from Segment 1 down to Segment 4 or from Segment 4 up to Segment 1. Those skilled will realize the direction of performing sequences has its own advantages with little impairements in choosing one direction over the other. In a preferred embodiment of the Series 8, the general order in performing the sequences can be seen in FIGS. 15B-15D with Segments 1 and 2 (steps 307 and 309) performed consecutively on one side, followed by a short walk. The other side of the body is then taken through Segments 1 and Segment 2 with a short walk (step 350) following the stretching of these two Segments. Segment 3 A and B can then be performed consecutively on one side of the body (steps 311A and 311B), followed by a short walk (step 350) and are performed again for the other side of the body. Then Segment 4 can be performed for each side of the body (step 313).

It will be appreciated that stretching the body in coordinated muscular postures can benefit from the use of an orientation device helping those using the Series 8 to prevent injury from improper placement of body parts during the performance of muscular postures. Referring to FIG. 8, to aid those in the use of the Series 8, an orientation device 100 is shown that comprises two linear markers 105 that intersect one another at right angles. Those skilled will understand that the orientation device 100 can form a cross or two lines intersecting in an L-shape. One example of selecting an orientation device involves using two pieces of tape that are roughly 1½ inches to 2 inches wide and 3½ feet to 4 feet in length. One piece of tape should be laid longitudinally oriented in the direction the person performing the exercises will be facing. The second piece of tape should be laid perpendicular over the first piece of tape. Another example can include a manufactured device made of soft flexible material, such as vinyl or the like, that is foldable and easily transportable on the person. Prior to performing the stretches in the Series 8, the orientation device 100 is laid on a floor surface with ample room around the vicinity of the patient to accommodate stretched out legs and bent torsos. The floor should be flat and the orientation device 100 should have sufficient traction to stay in place on the floor and include an upper surface with sufficient traction to prevent slippage by a person performing the stretches and stepping on the orientation device.

In performing the Series 8, a sequence of exemplary muscular postures targeting respective segments is herein described. When each segment as described references emphasis on one side of the body, it will be understood that the same sequence of postures for a particular segment can be performed on both sides of the body, by interchanging right and left body parts, where necessary. The individual steps in performing the Series 8 are described in the flow charg of FIGS. 15B-D.

Segment 1

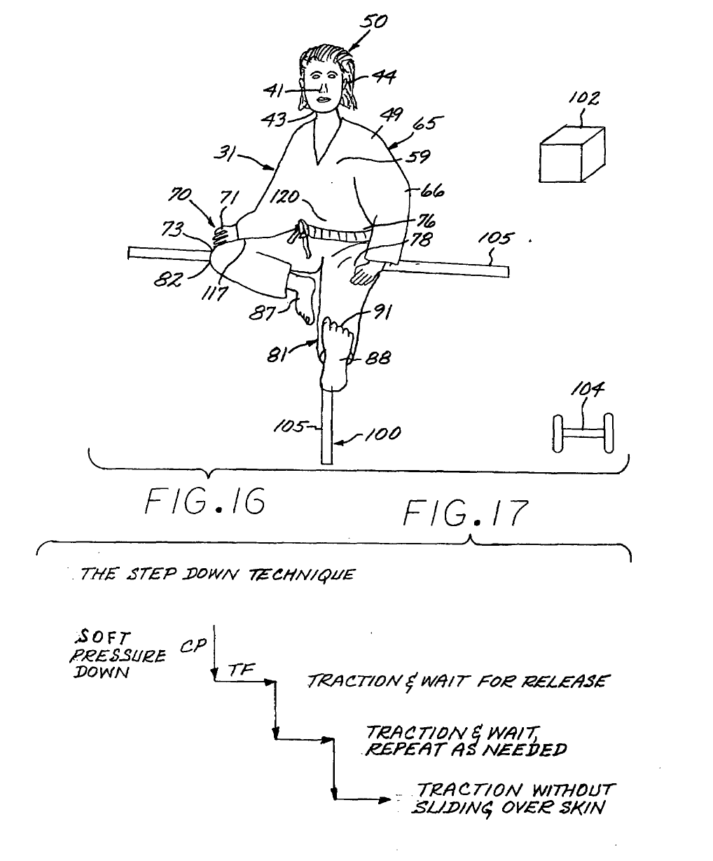

Referring to FIG. 16 and FIGS. 15B-D, an example starting position is shown that can be used for both segments 1 and 2. To arrive at this position, the patient is directed to step onto the orientation device 100 and align themselves facing the direction of one of the linear markers 105. The patient is then directed to take a seat on the orientation device 100 (step 320) sitting with the left leg 81 extended straight out along the first linear marker (the marker traversing forward and rearward of the body), and folding the right leg 81 inward at the knee 82 with the right foot 88 tucked in toward the torso 31 while maintaining the torso and head 50 erect. The right knee 82 should be aligned with and pointing generally in the direction of the second linear marker 105 (the marker traversing side to side of the body). The right hand 70 is placed on the inside medial part of the right ankle 87 and the right elbow 66 is rested on the right knee 82. The patient then leans the torso 31 sideways to the left so that the right hip 76 is lifted off the floor surface. The patient will then pull the right leg 81 and hip 76 backward posteriorly so that the right knee 82 now points in a range 30° to 45° clockwise in an angle relative to the normal of the second linear marker 105. The shoulders 49 are then rotated and squared perpendicular to the extended left leg 81 (step 325). The head 50 and chin 43 are rolled downward curling the upper spine 61 forward creating a rounded spine position. The head 50 is then tilted slightly to the left so that the left ear 44 is directly over the center of the left thigh 78 (step 330). The right hand 70 is placed so that the last knuckle of the forefinger 73 is directly on the occipital protuberance 55. Then place the left hand on top of the right hand. The shoulders 49 and arms 65 are then slowly dropped so the weight of the arms and shoulders bear down on the back of the head 50 facilitating a sharp and narrow stretch on the right body side from the base of the occiput 110 to the middle of the back 60 (step 335). The stretch in this posture can be improved by turning the nose 41 inward by rotating the head 50 only. It will be understood that moving the shoulders 49 side to side or rotating the torso 31 may detract from the stretch in this position. Applicant suggests to hold this position for four to six minutes. Optionally, to help increase the stretch and relax in the stretch, the patient may utilize a three to five pound weight 104 (FIG. 16) held in place on the back of the head 50 using the thumbs 71. In step 340, when prepared to come out of this posture, any weights 104 and one of the arms 65 should be dropped, then the other arm should be dropped without lifting the head 50 or chin 43 and maintaining a rounded spine 61. The hands 70 should slowly move behind the back 60 without using the trapezius muscle 48 or contracting any other muscles in an effort to use the least amount of energy possible. The patient should be directed to slowly lean the torso backwards with the weight of the body supported by the hands 70 and arms 65. The shoulders 49 should be pushed involuntarily upwards as a consequence of leaning the body weight onto the hands while maintaining the elbows 66 straight. The posture is terminated by lifting the chest 59 slowly and the dropping the head 50 into neutral. The patient is then instructed to stretch Segment 2 (step 309).

Segment 2

Referring again to FIG. 16, Segment 2 will also begin by aligning the body facing forward on the orientation device 100 and sitting on the orientation device with the left leg 81 extended straight out from the body along the first linear marker 105 and the right leg folded in at the knee 82 with the torso 31 held upright and erect and the right knee pointing perpendicularly to the right of the left leg in general alignment with the second linear marker (step 320). The patient grasps the right medial part of the ankle 87 with the right hand 40 while resting the right elbow 66 on the right knee 82. The patient will then lean the torso 31 to the left side so that the right hip 76 is lifted off the floor surface. The patient then pulls the right leg 81 and hip 76 backward posteriorly so that the right knee 82 now points in a range 30° to 45° clockwise in an angle relative to the normal of the second linear marker 105. The shoulders 49 should then be rotated squared perpendicular to the extended leg 81 (step 325). The patient will then bend the torso forward at the hips 76 keeping the back 60 straight (step 345). He or she will then tilt his or her head 50 so that the left ear 44 is aligned vertically over the center of the left thigh 78. In step 335, the right hand 70 is placed so that the last knuckle of the forefinger 73 is directly on the occipital protuberance 55 and the left hand is placed on top of the right hand. The shoulders 49 and arms 65 are then dropped so that the weight of the arms and shoulders bear down on the back of the head 50 facilitating a sharp and narrow stretch on the right side from the middle of the back 60 to the sacro-iliac joint 113. The stretch in this posture can also be improved by rotating the head 50 to turn the nose 41 inward toward the linear marker extending longitudinally to the right of the patient. Once again, it is suggested to hold this position for four to six minutes. Optionally, this stretch can also be deepened by utilizing a three to five pound weight 10 (FIG. 16) held in place on the back of the head 50 hung from the thumbs 71. The patient is then instructed per step 340, to come out of this posture releasing any weights 104 held and lowering the arms 65 one at a time to the sides of the body without lifting the head 50 or chin 43 and maintaining a straight back 60 and spine 61. The hands 70 should slowly move behind the back 60 without using the trapezius muscle 48 or contracting any other muscles in an effort to use the least amount of energy possible. The torso should slowly lean backwards with the weight of the body supported by the hands 70 and arms 65 (step 340). The shoulders 49 should be pushed involuntarily upwards as a consequence of leaning the body weight onto the hands and elbows 66 should remain straight. The posture is terminated by lifting the chest 59 slowly and dropping the head 50 into neutral. I recommend instructing the patient to stand up and take a short walk (step 350) before repeating the sequences for Segment 1 (step 307) and Segment 2 (309) on the other side of the body. I then instruct the patient through Segment 3 (step 311A).

Segment 3

Straight Knee (Segment 3A)

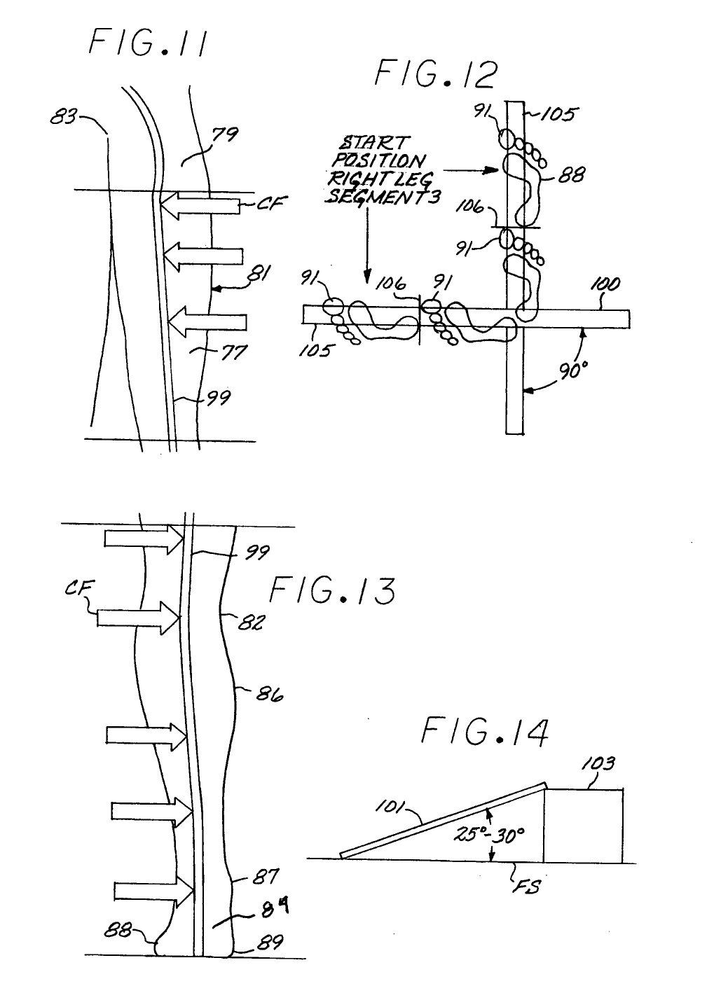

Referring to FIGS. 7, 12 and 15C, when practicing the embodiment employing Segment 3, I direct the patient in step 355 to place the feet 88 perpendicularly on the orientation device 100 with heels 89 in contact with one another. The toes 91 of each foot 88 point perpendicularly away from each other in alignment with the first and second linear markers 105. Using a writing device, a demarcation 106 is drawn perpendicularly across respective linear markers 105 at the front point of the longest toe 91 of respective feet. Each foot 88 is then moved forward along its linear marker 105 shifting positions a full foot length outward along the respective perpendicular line with the base of each heel 84 now being in front of each demarcation 106. Both knees 82 maintained straightened out while squaring the hips 76 and shoulders 49 to the right so they are parallel with the second linear marker 105 (step 360). The torso 31 is then bent forward, causing a mild hamstring 77 stretch (step 365). If necessary, the hands 70 may hold the lower leg or touch the ground to maintain balance and'support the weight of the body. This position should then be maintained for one to two minutes. The torso 31 is then raised upward to turn to stretch off (step 370). When ready, the torso 31 is slowly lowered down to the outside of the right leg 81 (maintained extended) with the head 50 also just outside of the right leg. The hands 70 should also slide down the right leg toward the floor to support the torso weight. This position should resemble a tripod with the fingertips on the floor to support the weight of the torso. The torso 31 should then be slowly shifted forward to align the bellybutton 120 vertically over the ankle joint 87 causing a deep stretch in the hamstring 77 (step 380). This posture should be maintained for at least three minutes with small forward adjustments incrementally increasing the stretch. To maximize the benefits of the stretch, the left hip 76 should be rotated anteriorly so that the top part of the hips moves slightly downward towards the floor surface while the base of the glutes 79 move slightly upward. To release the stretch in step 381, the left leg 81 should then be extended and the toes of the foot placed on the linear marker 105 behind the other leg being careful to avoid placing any weight on the toes 91 of the left foot. This posture should be held for 30 seconds to one. While holding the left leg 81 straight, it should be lifted off the ground about 16 inches and crossed over and behind the right leg, and both legs should be squeezed together in the upper tight area, while the head 50 is dropped forward. This posture should be held for 30 seconds to one minute. The stretch is then terminated by dropping the left foot 88 to the ground and bringing the left foot forward so that it is even with the right foot. Both knees 82 are then lowered into a deep bend and the hands 70 are placed on respective knees. The hands 70 are then walked up each leg 81, which in turn pushes the torso 31 into an upright position until torso extends straight up. The patient is then instructed to perform the sequence in Segment 3B (step 311B).

Bent Knee (Segment 3B)

In a bent knee version of Segment 3, it may be helpful to have a balancing device 102 or the like such a box, a crate, or a foam roller (step 385) nearby for gripping and supporting the body during stretch postures (FIG. 16). The straight knee version of segment 3 is the same as the straight knee except that step 390 is interchanged with step 375. In step 390, the squaring of the hips 76 and shoulders 49 to the right and subsequently bending forward remains the same, but instead of keeping the right leg 81 straight at the knee 82, the right knee is bent while the torso 31 is bent forward at the hips into a mild hamstring stretch. This first position should be maintained for at least one to two minutes. The torso 31 is then raised upward to release the stretch. The torso 31 is then smoothly lowered back down the outside of the right leg 81 with knee maintained bent, making sure the head 50 is just to the outside of the right thigh (step ______). The hand 70 should also then slide down the right leg 81 towards the floor to support the torso weight. If the hands 70 do not reach the floor, the balancing device 102 may be grasped to support the body off the floor. The patient then proceeds to step 380 where the body should once again slowly be shifted forward with the bellybutton 120 over the ankle joint 87. This posture should be maintained for at least three minutes with small forward adjustments incrementally increasing the stretch. The stretch is then released again in step 381 similarly to the sequence described in segment 3A. The patient then proceeds to perform the sequences of segment 3A and 3B (steps 311A and 311B) for the other side of the body before proceeding to segment 4 (step 313).

Segment 4

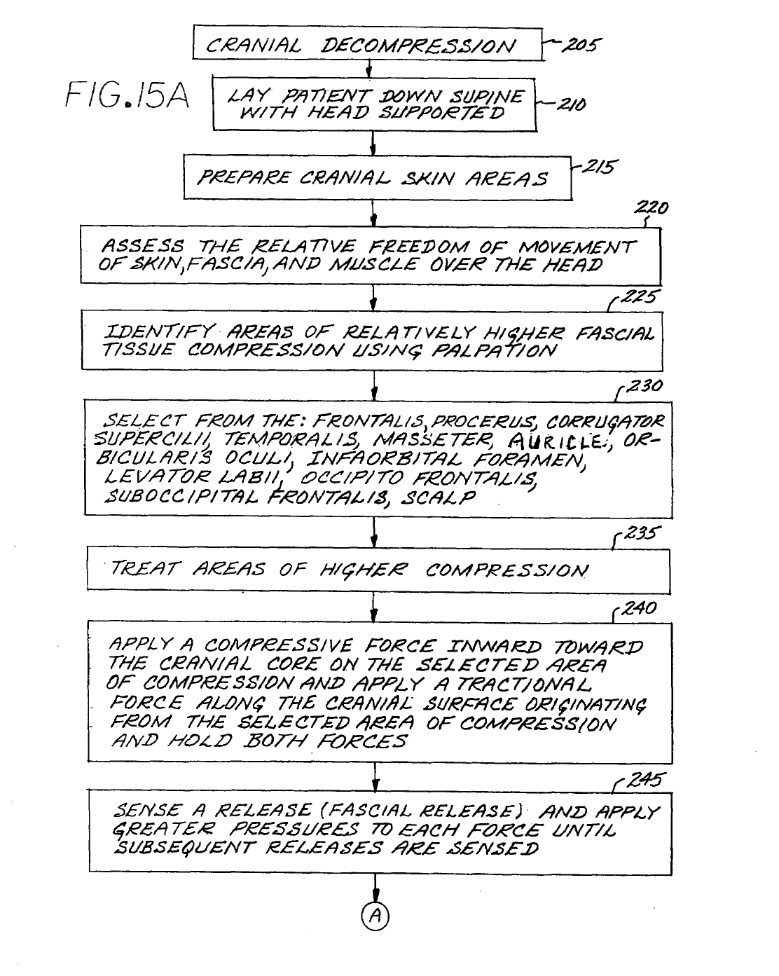

The last of the segments incorporates a platform board 101 to stretch the calf 86, Achilles' tendon 84, and foot 88 of each side of the body (FIGS. 13, 14 and 15D). A platform 101 is selected in step 400 that can be about 10 inches square and should be sturdy enough to support the entire body weight of the patient. One edge of the platform board 101 is placed on a support level 103 forming a 20° to 25° angle relative to the normal of the floor surface FS (FIG. 14) and (FIG. 15D, step 405). The stretch begins by placing a majority of the foot 88 onto the platform 101 and pivoting the forefoot slightly inward. The heel 89 of the foot is in firm contact with the floor surface FS and not on the board 101 itself (step 410). While standing up straight, the patient will move the hips forward (step 415), causing a stretch in the calf 86, Achilles' tendon 84, and foot 88. It will be understood that increasing the stretch intensity can be made by moving the hips farther forward, and likewise decreasing the stretch intensity can be done by moving the hips 76 rearward. It is important that the patient move the hips not the torso forward to gain the benefit of the stretch. This stretching posture should be held steady for at least two minutes and then released, (step 420) and repeated for the other side of the body (step 313).

From the foregoing, it will be appreciated that in the preferred embodiment of my method of releasing fascial tension from compressed fascial tissue may be applied to or incorporating the use of areas from a patients head or cranium, chin, forehead, nasal cavity, lips, a temporalis, an occipital protuberance, hair and a scalp and ears, eyes, back, chest, spine, and torso including a bellybutton and first and second body sides with respective hands including respective palms and fingers, legs, knees, toes, feet, heels, thighs, hips, shoulders, arms, and hands. The practitioner may first apply palpation to the fascial tissues of the head to tactilely identify compressed fascial tissue areas and then treat the respective identified compressed fascial tissue areas by applying a manual pressure to respective compressed fascial tissue areas until a tactilely identified decompression of tension is sensed in respective compressed fascial tissue areas. The practitioner may then select an orientation device including first and second linear markers perpendicular to one another forming an intersection to be positioned flat on a floor surface when the practitioner is satisfied with the amount of decompression administered to the head, the practitioner may direct the patient through a sequence of stretches. In summary it will be appreciated that the practitioner may direct the patient to perform a first stretch of the body by directing the patient to:
i. sit on the orientation device with one leg extended straight out in alignment with the first linear marker and the other leg of the other body side folded inward toward the body with that knee in alignment with the second linear marker;
ii. reach for and hold the ankle of the other leg while resting the elbow of such other side on the other knee;
iii. lean the torso to the one body side raising the opposite hip off the floor surface;
iv. hold the one leg in position while pulling the other leg and hip rearwardly from the second linear marker;
v. square the shoulders perpendicular to the one foot;
vi. roll the head and chin downward curling the upper spine forward;
vii. position the patient's head vertically over the center of the thigh on the one side;
viii. place the hand on the other side of the body on the back of the head;
ix. drop the shoulders and arms so the weight of the shoulders and arms bear down on the back of the to generate a first stretch;
x. hold the first stretch for a predetermined period of time;
xi. drop the arms one at a time moving the hands behind the back to rest on the floor and leaning backward supporting the body with the arms while lifting the chest up slowly and allowing the head to drop into a position neutral;

perform a second stretch including:
xii. sit on the orientation device with a first leg on a first side of the body extended straight out forwardly in alignment with the first linear marker and the second leg folded inward toward the body with the second side knee in alignment with the second linear marker;
xiii. reach for and hold the medial part of the second ankle and rest the second body side elbow on the second knee;
xiv. lean to the first side of the body to raise the second body side hip off the floor;
xv. pull the second body side leg and hip rearwardly behind the second linear marker while maintaining the first leg in position;
xvi. square the shoulders to the first body side foot of the first leg;
xvii. hold the position while bending forward at the hips and maintaining the back straight;
xviii. position the head vertically over the center of the first body side thigh;
xix. place the second body side hand on the back of the head and the first body side hand on top of the second body side hand;
xx. drop the shoulders and arms so the weight of the shoulders and arms bear down on the back of the head facilitating a second stretch on the second body side;
xxi. hold the second stretch for a selected period of time;
xxii. drop each arm one at a time moving the hands behind the back to rest on the floor and leaning backward supporting the body with the arms while lifting the chest up slowly and allowing the head to drop into a neutral position;

perform the first stretch interchanging the one an other legs including instructing the patient to:
xxiii. sit on the orientation device with the second other leg straight out in alignment with the first linear marker and the first leg and knee folded inward toward the body and one body side knee in alignment with the second linear marker;
xxiv. reach for and hold the one body side ankle and resting the one body side elbow on the one body side knee;
xxv. lean the torso to the other body side to raise the one body side hip off the floor;
xxvi. with the first leg still extended forwardly, pull the one body side leg and hip rearwardly behind the second linear marker;
xxvii. square the shoulders to the other body side foot;
xxviii. roll the head and chin downward curling the upper spine forward;
xxix. position the head vertically over the center of the other body side thigh;
xxx. place the one body side hand on the back of the head;
xxxi. drop the shoulders and arms so the weight of the shoulders and arms bear down on the back of the head facilitating a third stretch on the one body side;
xxxii. hold the third stretch for a selected predetermined period of time;

performing a fourth stretch involving the second stretch interchanging the second body side and first body side legs including the direction to:
xxxiii. sit on the orientation devices with the second body side leg straight out in alignment with the first linear marker and the first body side leg folded inward toward the body and first body side knee in alignment with the second linear marker;
xxxiv. reach for and hold the medial part of the first body side ankle while resting the first body side elbow on the first body side knee;
xxxv. lean to the second body side raising the first body side hip off the floor;
xxxvi. pull the first body side leg and hip rearwardly from the second linear marker;
xxxvii. square the shoulders to the second body side foot;
xxxviii. bend forward at the hips while maintaining the back straight;
xxxix. position the head vertically over the center of the second body side thigh;
xl. place the first body side hand on the back of the head and the second body side hand on top of the first body side hand;
xli. drop the shoulders and arms so the weight of the shoulders and arms bear down on the back of the head to facilitate a stretch on the first body side;
xlii. hold the fourth stretch for a predetermined period of time;
xliii. drop each arm one at a time moving the hands behind the back to rest on the floor and lean backward to support the upper torso with the arms while lifting the chest up slowly and allowing the head to drop into neutral position;

perform a fifth stretch by directing the patient to:
xliv. stand on the orientation device with the second body side and first body side heels in contact with one another at the intersection and the toes of respective feet pointed perpendicularly outward along respective first and second linear markers;
xlv. marking the position of respective toes with respective delineations on respective linear markers;
xlvi. advance respective feet forward along respective linear markers until the back of respective heels are positioned on respective delineations;
xlvii. bend the knees;
xlviii. square the hips and shoulders to the second body side aligned with the second body side foot;
xlix. bend the torso forward to stretch the second body side hamstring;
1. hold the torso forward for the predetermined amount of time;
li. raise the torso upward and lower the torso toward the outside of the second body side leg while also sliding the patient's hands down the outside of the second body side leg and rotating the first body side hip anteriorly;
lii. shift the torso forward to a position vertically above the second body side ankle joint;
liii. hold the torso over the second body side ankle joint for the predetermined amount of time;
liv. extend the first body side leg straight and move the first body side foot behind the second body side foot maintaining the first body side leg straight;
lv. hold the first body side foot behind the second body side foot for the predetermined time;
lvi. lift the first body side leg off the ground;
lvii. cross the first body side leg over the front of the second body side leg;
lviii. squeeze the legs together and drop the head;
lix. hold the legs squeezed together and the head dropped for the predetermined time;
lx. lower the first body side foot to the ground and align the first body side foot even with the second body side foot with both parallel to one another;
lxi. bend both knees;
lxii. place the first body side hand on the first body side knee and the second body side hand on the second body side knee;
lxiii. walk the patient's hands up respective legs while pushing the torso upward into an upright body side position;

performing a sixth stretch including:
lxiv. selecting a gripping object and directing the patient to;
lxv. stand on the orientation device with the second body side and first body side heels in contact with one another at the intersection and the toes of respective feet pointed perpendicularly outward along respective first and second linear markers;
lxvi. marking the position of respective toes with respective delineations on respective linear markers;
lxvii. directing the patient to advance respective feet forward along respective linear markers until the back of respective heels are positioned on the respective delineations;
lxviii. square the hips and shoulders to the second body side aligned with the second body side foot;
lxix. bend the first body side knee while maintaining the second body side leg straight;
lxx. bend the torso forward to stretch the second body side hamstring;
lxxi. hold the torso forward for the predetermined amount of time;
lxxii. raise the torso upward and lower the torso toward the outside of the second body side leg while also sliding his or her hands down the outside of the second body side leg and rotating the first body side hip anteriorly;
lxxiii. support the upper torso with the hands supported from the floor surface;
lxxiv. shift the torso forward above the second body side ankle joint;
lxxv. hold the torso over the second body side ankle joint for the predetermined amount of time;
lxxvi. hold the first body side foot behind the second body side foot for the predetermined amount of time;
lxxvii. lift the first body side leg off the ground;
lxxviii. cross the first body side leg over the front of the second body side leg;
lxxix. squeeze the legs together and drop the head;
lxxx. hold the legs squeezed together and head dropped for the predetermined time;
lxxxi. drop the first body side foot to the ground and align the first body side foot even with the second body side foot with both feet parallel to one another;
lxxxii. bend both knees;
lxxxiii. place the first body side hand on the first body side knee and the second body side hand on the second body side knee;
lxxxiv. walk the hands up respective legs while pushing the torso upward into an upright body side position;

performing a seventh stretch interchanging second body side and first body side legs of the seventh stretch including directing the patient to:
lxxxv. stand on the orientation device with the second body side and first body side heels in contact with one another at the intersection and the toes of respective feet pointed perpendicularly outward along respective first and second linear markers;
lxxxvi. marking the position of respective toes with respective delineations on respective linear markers and directing the patient to;
lxxxvii. advance the respective feet forward along respective linear markers until the back of respective heels are positioned on respective delineations;
lxxxviii. bend his or her knees;
lxxxix. square the hips and shoulders to the first body side aligned with the first body side foot;
xc. bend the torso forward and stretching the first body side hamstring;
xci. hold the torso forward;
xcii. raise the torso upward and lowering the torso toward the outside of the first body side leg while also sliding the hands down the outside of the first body side leg and rotating the second body side hip anteriorly;
xciii. shift the torso forward above the first body side ankle joint;
xciv. hold the torso over the first body side ankle joint;
xcv. extend the second body side leg straight and move the second body side foot behind the first body side foot while maintaining the second body side leg straight;
xcvi. hold the second body side foot behind the first body side foot;
xcvii. lift the second body side leg off the floor;
xcviii. cross the second body side leg over the front of the first body side leg;
xcix. squeeze the legs together and drop the head;
c. hold the legs squeezed together and head dropped;
ci. drop the second body side foot to the floor and align the second body side foot even with the first body side foot with the feet parallel to one another;
cii. bend both knees;
ciii. place the second body side hand on the second body side knee and the first body side hand on the first body side knee;
civ. walk the hands up respective legs while pushing the torso upward into an upright position;

performing an eighth stretch involving the fourth stretch interchanging second body side and first body side legs including directing the patient to:
cv. stand on the orientation device with the second body side and first body side heels in contact with one another at the intersection and the toes of respective feet pointed perpendicularly outward along respective first and second linear markers;
cvi. mark the position of respective toes with respective delineations on respective linear markers and direct the patient to;
cvii. advance the respective feet forward along respective linear markers until the back of respective heels are positioned on respective delineations;
cviii. square the hips and shoulders to the first body side aligned with the first body side foot;
cix. bend the second body side knee and maintain the first body side leg straight;
cx. bend the torso forward stretching the first body side hamstring;
cxi. hold the torso forward;
cxii. raise the torso upward and lowering the torso toward the outside of the first body side leg while also sliding hands down the outside of the first body side leg while rotating the second body side hip anteriorly;
cxiii. support the body with the hands supported from the floor surface;
cxiv. shift the torso forward above the first body side ankle joint;
cxv. hold the torso over the first body side ankle joint;
cxvi. hold the second body side foot behind the first body side foot;
cxvii. lift the second body side leg off the ground;
cxviii. cross the second body side leg over the front of the first body side leg;
cxix. squeeze the legs together and drop the head;
cxx. hold the legs squeezed together and head dropped;
cxxi. drop the second body side foot on the floor and align the second body side foot even with the first body side foot whereby both feet point parallel to one another;
cxxii. bend both knees;
cxxiii. place the first body side hand on the first body side knee and the second body side hand on the second body side knee;
cxxiv. walk the hands up the respective legs while pushing the torso upward into an upright body side position;

performing a ninth stretch including:
cxxv. selecting a platform;
cxxvi. placing the platform on an incline with the bottom edge of the platform in contact with the floor surface and directing the patient to;
cxxvii. place the second body side foot on the platform maintaining the second body side heel in contact with the floor surface;
cxxviii. shift the hips forward to stretch the second body side calf muscle;
cxxix. maintain the hips forward stretching the second body side calf muscle;
cxxx. place the first body side foot on the platform while maintaining the first body side heel in contact with the floor surface;
cxxxi. shift the hips forward stretching the first body side calf muscle; and
cxxxii. maintain the hips forward stretching the first body side calf muscle.

In practice, it will be appreciated that the FRS is conducive to treating physical pain targeting the entire body with the aid of simple devices to provide a full body decompression of tensional imbalances. As one experiences compressed fascial tissue, those skilled will recognize that the FRS 30 can be administered in locations of relative convenience anywhere there is sufficient room to extend limbs and bend forward. As described, the system can be performed where a patient is comfortable without resorting to external machinery. It will be further appreciated that as performed, administering the FRS systematically decompresses tensions in directions outward from the extremities of the body. As the compressions in cranial tissue are released from surrounding connective tissue, the head becomes relaxed commencing a domino effect of tensional release toward the rest of the body. The neck, shoulders and trapezius also begin decompressing as tissues at the base of the cranium release tension connected to these muscles. These muscles and their connected tissue are then slowly elongated stretching out contractions linearly down the torso. As one segment of muscles are elongated, the subsequently connected muscles and tissue are also affected with a release of tissue contractions traveling along the spine and limbs. As tissue elongates, blood flow and oxygenation to the muscles increases creating a sensation of relaxation flowing out towards the limbs. When relaxed, the brain and body tissues can then once again return to their naturally balanced state of tension providing improved skeletal support, posture and a sense of pain relief.

It will also be appreciated that the FRS is also helpful in preventing further injury during treatment. By incorporating an orientation device 100 and balancing device 102, patients can mitigate hyper extending joints and connective tissue. By positioning body parts according to a reference point, (orientation device markers), muscle tissue, fascia, tendons and ligaments are maintained within an operable range of movement. Similarly, muscles and fascia are moved slowly and deliberately in reference to the orientation device 100, successively elongating tissues while warming up adjacent muscular areas in preparation for their own stretch sequence. Patients can also maintain balance during standing/bent over stretches by supporting themselves with the balancing aid 102 preventing falls.

Finally, the FRS can be performed without the assistance of elaborate equipment or machinery. When the stresses of daily activity or chronic pain are felt, a patient can proceed to a nearby relatively open area, pull up a chair, perform the cranial decompression, then lay down an orientation device and proceed right into the Series 8.

Thus, as described herein, the Fascial Release System of the present invention demonstrates a new and useful method for treating soft tissue pain in the human body.

I claim:

1. A method of releasing fascial tension from compressed fascial tissue areas from a subject's head, including;
i. applying palpation to the fascial tissues of the head and tactilely identifying first compressed fascial tissue areas;
ii. treating the first compressed fascial tissue area by applying a first manual pressure inward on the first compressed fascial tissue area and concurrently applying a second manual pressure inwardly to and elongating the first compressed fascial area away from the first manual pressure until a tactilely identified decompression of tension is sensed in the first compressed fascial tissue area;
iii. repeating step ii to the first identified compressed fascial area;
iv. tactilely examining the first identified compressed fascial area to sense any decompression;
v. applying palpation to other fascial tissue areas of the head to tactilely identify second compressed fascial tissue areas;
vi. treating the second compressed fascial tissue areas using the treatment of step ii.
vii. repeating step v; and
viii. tactilely examining the second identified compressed fascial area to sense any decompression.

2. The method of claim 1 that includes repeating step ii to the second identified compressed fascial area and repeating step iv until decompression of the second identified compressed fascia area is sensed.

3. The method of claim 1 that includes repeating step v and step viii until examination reveals the second identified compressed fascial area has been decompressed.

4. The method of releasing fascial tension of claim 1, wherein:
the step of applying palpation to the fascial tissues of the head includes identifying areas of relatively higher compressed fascial tissue and areas of relatively lower compressed fascial tissues; and
step ii includes treating the areas of relatively higher compressed fascial tissue before treating the areas of relatively lower compressed fascial tissues.

5. The method of releasing fascial tension of claim 1, wherein:
the step of applying palpation includes locating a frontalis on the head; and wherein
step ii treats the frontalis and includes applying the first manual pressure inward on the frontalis and then applying the second manual pressure upward along the cranium surface.

6. The method of releasing fascial tension of claim 1, wherein:
the step of applying palpation includes locating a corrugator supercihii, an eye, a nasal cavity, and a temporalis on the head; and wherein
step ii treats the corrugator supercilii by applying the first manual pressure inward in an area above the nasal cavity and below the eye and applying the second manual pressure along the cranial surface toward the temporalis.

7. The method of releasing fascial tension of claim 1, wherein:
the step of applying palpation includes locating a masseter, a mandible joint, a pair of lips and a temporalis on the head; and wherein
step ii treats the masseter by applying the first manual pressure inward adjacent the mandible joint and applying the second manual pressure along the surface of the cranium from the pair of lips toward the temporalis.

8. The method of releasing fascial tension of claim 1, wherein:
the step of applying palpation includes locating an auricle including a top edge, a bottom edge and a rearward edge on the head; and wherein
step ii treats the auricle by grasping and compressing respective top, bottom and rearward edges and drawing the respective edges in predetermined directions.

9. The method of releasing fascial tension of claim 1, wherein:
the step of applying palpation includes locating an obicularis oculi and an eye surrounded by the obicularis oculi and an eyebrow located on a top extremity of the obicularis oculi on the head; and wherein
step ii treats the obicularis oculi by applying the first manual pressure inward intermediate the eye and the eyebrow and applying the second manual pressure diagonally rearward across the cranial surface.

10. The method of releasing fascial tension of claim 1, wherein:
the step of applying palpation includes locating an obicularis oculi, a nasal cavity on the head and an infraorbital foramen intermediate the obicularis oculi and the nasal cavity; and wherein
step ii treats the infraorbital foramen by applying a compression intermediate the obicularis oculi and the nasal cavity until a tactilely identified decompression of tension is sensed in the forearm.

11. The method of releasing fascial tension of claim 1, wherein:
the step of applying palpation includes locating an obicularis oculi and a procerus on the head and a levator labii adjacent the obicularis oculi; and wherein
step ii treats the levator labii by applying a the first manual pressure on the levator labii and applying the second manual pressure diagonally along the cranial surface toward the procerus.

12. The method of releasing fascial tension of claim 11, wherein:
the step of applying palpation includes locating an obicularis oculi and a mandible on the head and a levator labii adjacent the obicularis oculi; and wherein
step ii treats the levator labii by applying a the first manual pressure on the levator labii and applying the second manual pressure diagonally along the cranial surface toward the mandible.

13. The method of releasing fascial tension of claim 1, wherein:
the step of treating the occciptofrontalis includes locating a frontalis on the front of the head and an occiput on the rear of the head with the muscle tissue intermediate the frontalis and occiput defining the occciptofrontalis; and wherein
step ii treats the occciptofrontalis by positioning a hand over the occiput and the other hand on the frontalis and applying the first manual pressure inward toward a core of the cranium with respective hands while applying the second manual pressure in a confronting direction toward one another with respective hands.

14. The method of releasing fascial tension of claim 1, wherein:
the step of treating the suboccipital muscles includes locating a downwardly and rearwardly facing surface on the cranium and applying a palm to the downwardly and rearwardly facing surface and pressing the palm upwardly along a rearward facing surface of the cranium to release the fascial tension in the compressed fascial tissue.

15. The method of releasing fascial tension of claim 1, wherein:
the step of treating procerus muscles includes locating a temporalis muscle, a frontalis muscle and a nasal cavity on the head and a procerus muscle connected between the frontalis and the nasal cavity; and wherein
step ii treats the procerus muscle by placing a palm of a hand on the temporalis muscle and applying a compressive force with a thumb of the hand on the procerus muscle.

16. The method of releasing fascial tension of claim 1, wherein:
includes treating compressed fascial tissue connected to the scalp of the head by grasping the patient's hair and pulling the hair to draw the scalp from the connected compressed fascial tissue.

17. A method for treating compressed fascial tissue in a patient body, including;
i. selecting an orientation device including first and second linear markers configured perpendicular to one another and setting the orientation device on a floor surface;
ii. instructing the patient to sit facing forwardly on the first linear marker with a first leg extended forwardly along the first linear marker and to fold the second leg inward from the knee with the foot toward the body and the knee aligned vertically over the second linear marker;
iii. instructing the patient to grasp the knee and pull the knee to a position located rearward the second linear marker;
iv. instructing the patient to square the shoulders extended in a plane perpendicular to the longitudinal direction of the first leg;
v. instructing the patient to roll the head and chin downward curling the upper spine forwardly while positioning the head vertically over the first leg into a first stretch position;
vi. instructing the patient to hold the first stretch position for a predetermined period of time and then release the first stretch position;
vii. instructing the patient to repeat steps ii.-iv.
viii. instructing the patient to bend forward at the hips maintaining the back straight while positioning the head vertically over the first leg into a second stretch position;
ix. instructing the patient to hold the second stretch position for a selected period of time and releasing the second stretch position;
x. instructing the patient to stand up and position his or her respective heels in contact with one another and with the respective forefeet pointed perpendicularly outward along respective linear markers;
xi. instructing the patient to advance respective feet forward substantially one foot length outwardly along respective linear markers;
xii. instructing the patient to bend the knees and square the hips and shoulders extended in a plane perpendicular to the longitudinal direction of a first foot;
xiii. instructing the patient to bend the torso forward into a third stretch position and hold the third stretch position for another predetermined amount of time and then releasing the third stretch position;
xiv. selecting a platform device and supporting the platform device on an incline to the floor surface;
xv. instructing the patient to place the forefoot of the first foot on the platform device while maintaining the heel in contact with the floor surface; and
xvi. shifting the hips forward into a fourth stretch position for a another selected period of time and releasing the fourth stretch position.

18. The method of treating compressed fascial tension of claim 17, wherein:
step xiii includes instructing the patient to shift the torso forward and positioning the bellybutton over the ankle of the first foot.

19. The method of treating compressed fascial tension of claim 17, wherein:
step iii includes instructing the patient to pull the knee in a range 30-45 degrees rearwardly from the normal of the second linear marker.

20. The method of treating compressed fascial tension of claim 17, further comprising:
between steps viii and ix, rotating the head to turn the nose laterally toward the folded leg.

21. The method of treating compressed fascial tension of claim 17, wherein:
step v includes instructing the patient to hold the occipital protuberance while rolling the head and chin downward.

22. The method of treating compressed fascial tension of claim 17, further comprising:
repeating steps x-xiii wherein step xiii. is performed with the knees maintained straight during the act of bending the torso forward.

23. The method of treating compressed fascial tension of claim 17, wherein:
the step of selecting the orientation device includes selecting a pair of connected linear markers manufactured from a soft flexible material.

24. The method of treating compressed fascial tension of claim 17, wherein:
step xiv, the step of supporting the platform device includes supporting the platform device at an angle of between 20°-25° to the floor surface.

25. The method of treating compressed fascial tension of claim 17, further comprising:
selecting a balancing object and between steps ix and x, placing the balancing object on the floor surface adjacent a predetermined foot.

26. The method of treating compressed fascial tension of claim 25, wherein:
the step of selecting a balancing object includes selecting an object at least 6 inches in length.

27. The method of treating compressed fascial tension of claim 25, wherein:
the step of selecting a gripping object includes selecting a box.

28. A method of releasing fascial tension from compressed fascial tissue areas from a patient's head and body, including:
i. applying palpation to the fascial tissues of the head and tactilely identifying compressed fascial tissue areas;
ii. treating respective identified compressed fascial tissue areas by concurrently applying an inwardly pressed manual pressure and perpendicularly applied tractional force to the compressed fascial tissue areas along an adjacent cranial skin surface until a tactilely identified decompression of tension is sensed;
iii. repeating step ii at least 3 times;
iv. selecting an orientation device including first and second linear markers perpendicular to one another forming an intersection and positioning the device flat on a floor surface;
v. instructing the patient to sit forwardly on the intersection of the orientation device with a first leg extended forwardly along the first linear marker and the second leg folded inward from the knee with the. second leg foot pointed toward the body and the knee pointing laterally outwardly at an angle of between 120°-135° from the normal of the first leg;
vi. instructing the patient while maintaining the position of step v, to square the shoulders extended in a plane perpendicular to the first leg and to then roll the head and chin downward curling the upper spine forward while positioning the head vertically over the first leg into a first stretch position;
vii. instructing the patient to hold the first stretch position for a predetermined period of time and then to release the first stretch position;
viii. instructing the patient to repeat step v;
ix. instructing the patient to, while maintaining the position of step v, square the shoulders extended in a plane perpendicular to the first leg and to then bend forward at the hips while maintaining the back straight and positioning the head vertically over the first leg into a second stretch position for a selected period of time and then to release the second stretch position;
x. instructing the patient to stand on the orientation device with respective heels substantially a foot length forward from the intersection with the respective forefeet pointed perpendicularly outward along respective linear markers;
xi. instructing the patient to bend the knees slightly and square the hips and shoulders extended in a plane perpendicular to the longitudinal direction of a first foot;
xii. instructing the patient to then bend the torso forward into a third stretch position and hold the third stretch position for another predetermined amount of time and to then release the third stretch position;
xiii. selecting a platform device and placing a top edge the platform device on a raised support inclined from the floor surface;
xiv. instructing the patient to place a forefoot of the first foot on the platform device and to maintain the first foot heel in contact with the floor surface; and
xv. instructing the patient to shift the hips forward into a fourth stretch position for a predetermined period of time and to then release the fourth stretch position.
